(19) United States
(12) Patent Application Publication
(10) Pub. No.: US 2010/0231175 A1
(43) Pub. Date: Sep. 16, 2010

(54) POWER SUPPLY CIRCUIT, CHARGING UNIT HAVING THE POWER SUPPLY CIRCUIT, AND POWER SUPPLY METHOD

(75) Inventor: Ippei Noda, Osaka (JP)

Correspondence Address: DICKSTEIN SHAPIRO LLP, 1825 EYE STREET NW, Washington, DC, 20006-5403, US

(73) Assignee: RICOH COMPANY, LTD., Tokyo (JP)

(21) Appl. No.: 12/293,773

(22) PCT Filed: Dec. 4, 2007
(86) PCT No.: PCT/JP2007/073748

§ 371 Date: Sep. 19, 2008

(30) Foreign Application Priority Data
Feb. 14, 2007 (JP) 2007-033061

(51) Int. Cl. H02J 7/04

(52) U.S. Cl. 320/162

(57) ABSTRACT

A power supply circuit supplying power to a charge control circuit charging a secondary battery is disclosed. The power supply circuit includes a direct-current power supply configured to generate and output a predetermined voltage; and a DC-DC converter configured, to detect the voltage of the secondary battery, convert the predetermined voltage input from the direct-current power supply into a voltage according to the detected voltage of the secondary battery, and output the converted voltage to the charge control circuit.

### TECHNICAL FIELD

The present invention relates generally to power supply circuits supplying power to a charge control circuit charging a secondary battery, charging units having the power supply circuits, and methods of supplying power to the charge control circuit, and more particularly to a power supply circuit supplying power to a charge control circuit capable of performing charging with high efficiency even in the case of using a power generation element such as a fuel cell or a solar cell as a power supply, a charging unit having the power supply circuit, and a method of supplying power to the charge control circuit.

### BACKGROUND ART

Secondary batteries, in particular lithium-ion batteries recently, are often used in portable electronic apparatuses for reasons of economics, convenience, and power output density.

Further, the applications of portable electronic apparatuses are ever increasing, and terrestrial digital broadcasting, so-called one-segment broadcasting, has been started recently so that it is becoming common to watch television on portable electronic apparatuses. As a result, there has been a dramatic increase in the power consumption of portable electronic apparatuses. On the other hand, portable electronic apparatuses that use lithium-ion batteries, which are satisfactory in terms of output (power) density but are short of energy density, can only operate for a short period of time. Further, improvement in battery performance cannot keep pace with the increase in the power consumption of portable electronic apparatuses, so that the operating time of portable electronic apparatuses has failed to meet users' demands.

In order to resolve this situation, it has been expected to use fuel cells for power supply. In particular, passive DMFCs (Direct Methanol Fuel Cells), which use methanol as fuel but do not use an auxiliary machine such as a pump, can be reduced in size and are considered promising as power supplies for small-size portable electronic apparatuses such as cellular phones.

The energy density of the fuel cell is approximately ten times as much per weight and three times as much even per volume as that of the lithium-ion cell. In addition, the fuel cell, which is enabled to continuously supply power by adding methanol, can satisfy the demand for the operating time of portable electronic apparatuses. However, the output density of the fuel cell is too low to satisfy the demand of current portable electronic apparatuses.

Therefore, a charging unit that uses a current fuel cell to charge a secondary battery is possible. In the case of charging the secondary battery using the fuel cell, it is very important to improve charging efficiency in order to make as effective use of limited fuel as possible. However, the conventional charging unit using an AC adapter, which focuses more on shortening the charging time than on charging efficiency, does not have good charging efficiency.

FIG. 1 is a block diagram showing a conventional charging unit. In the charging unit of FIG. 1, the power loss generated based on the difference between the output voltage Vout1 of a DC-DC converter 130 and the voltage Vout2 of a secondary battery 120 is all consumed by a charge control circuit 140.

A smaller difference between the output voltage Vout1 of the DC-DC converter 130 and the voltage Vout2 of the secondary battery 120 and a smaller charging current are better to reduce power consumption in the charge control circuit 140. However, the output voltage Vout1 of the conventional DC-DC converter 130 is constant, and moreover, constant current charging is performed until the secondary battery 120 is fully charged. As a result, if the voltage Vout2 of the secondary battery 120 is low, there is a large difference from the output voltage Vout1 of the conventional DC-DC converter 130, and the charging current is also large. This results in an extremely large power loss in the charge control circuit 140. Such power loss is supplied entirely from a direct-current (DC) power supply 110. Thus, the charging efficiency of the conventional charging unit is not good.

FIG. 2 is a block diagram showing a conventional charging unit using a fuel cell. (See, for example, Japanese Translation of PCT International Application No. 2006-501798.)

In FIG. 2, an operational amplifier circuit 163 outputs an output signal according to the difference between the output voltage of a fuel cell 161 and a reference voltage Vref to a switch controller 164 so as to control the duty cycle of the switching element of a DC-DC converter 162. Referring to FIG. 2, the DC-DC converter 162 is caused to operate as an unregulated power supply by equalizing the output voltage of the DC-DC converter 162 with the voltage across a secondary battery 165 by directly connecting the secondary battery 165 to the output terminals of the DC-DC converter 162. Therefore, in the charging unit of FIG. 2, the power loss due to the charge control circuit 140 shown in FIG. 1 is eliminated so that the charging efficiency, is improved. Further, in the charging unit of FIG. 2, the output voltage or output current of the fuel cell 161 is dynamically controlled so as to be a desired value, thereby optimizing the power output and fuel efficiency of the fuel cell 161. In FIG. 2, reference numeral 166 denotes a load.

In the charging unit of FIG. 2, however, a current bypass circuit (not graphically illustrated) is provided so as to prevent the output voltage of the DC-DC converter 162 from exceeding the allowable voltage of the secondary battery 165, so that the current bypass circuit bypasses the output current of the DC-DC converter 162 after the secondary battery 165 is fully charged. Therefore, there is a problem in that the current bypass circuit wastes power after the secondary battery 165 is fully charged.

Further, the charging unit of FIG. 2 cannot perform constant-current, constant-voltage charging, which is commonly practiced as a lithium-ion battery charging method, and accordingly cannot perform charging with high accuracy. Therefore, there is a problem in that the charging current may be excessively supplied if the voltage of the secondary battery 165 is low and that the voltage across the fully charged secondary battery 165 cannot be determined with accuracy.

### DISCLOSURE OF THE INVENTION

Embodiments of the present invention may solve or reduce one or more of the above-described problems.

According to one embodiment of the present invention, there are provided a power supply circuit supplying power to a charge control circuit, a charging unit having the power supply circuit, and a method of supplying power to the charge control circuit in which one or more of the above-described problems may be solved or reduced.

According to one embodiment of the present invention, there are provided a power supply circuit supplying power to a charge control circuit capable of performing common constant-current, constant-voltage charging and improving charging efficiency; a charging unit having the power supply circuit; and a method of supplying power to the charge control circuit.

According to one embodiment of the present invention, there is provided a power supply circuit supplying power to a charge control circuit charging a secondary battery, the power supply circuit including a direct-current power supply configured to generate and output a predetermined voltage; and a DC-DC converter configured to detect a voltage of the secondary battery, convert the predetermined voltage input from the direct-current power supply into a voltage according to the detected voltage of the secondary battery, and output the converted voltage to the charge control circuit.

According to one embodiment of the present invention, there is provided a charging unit charging a secondary battery, the charging unit including a charge control circuit configured to charge the secondary battery; and a power supply circuit configured to supply power to the charge control circuit, wherein the power supply circuit includes a direct-current power supply configured to generate and output a predetermined voltage; and a DC-DC converter configured to detect a voltage of the secondary battery, convert the predetermined voltage input from the direct-current power supply into a voltage according to the detected voltage of the secondary battery, and output the converted voltage to the charge control circuit.

According to one embodiment of the present invention, there is provided a method of supplying power to a charge control circuit charging a secondary battery, the method including detecting a voltage of the secondary battery; and converting a predetermined voltage input from a direct-current power supply into a voltage according to the detected voltage of the secondary battery, and outputting the converted voltage to the charge control circuit.

In a power supply circuit supplying power to a charge control circuit, a charging unit having the power supply circuit, and a method of supplying power to the charge control circuit according to one or more embodiments of the present invention, the voltage of a secondary battery is detected, and a predetermined first voltage input from a first direct-current power supply is converted into a voltage according to the detected voltage of the secondary battery and output to the charge control circuit. This makes it possible to perform common constant-current, constant-voltage charging on the secondary battery. Accordingly, it is possible to charge the lithium-ion battery, whose charging conditions are strict, with high accuracy, so that it is possible to supply the charge control circuit with a voltage that is the battery voltage of the secondary battery plus a required minimum voltage at the time of charging the secondary battery using a fuel cell or a solar battery. As a result, the power loss in the charge control circuit is significantly reduced, so that it is possible to improve charging efficiency.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a conventional charging unit;

FIG. 2 is a block diagram showing a conventional charging unit using a fuel cell;

FIG. 3 is a schematic block diagram showing a charging unit according to a first embodiment of the present invention;

FIG. 4 is a graph showing changes in the output voltage of a DC-DC converter and the battery voltage of a secondary battery at the time of charging according to the first embodiment of the present invention;

FIG. 5 is a circuit diagram showing a charging unit according to a second embodiment of the present invention; and

FIG. 6 is a circuit diagram showing a charging unit according to a third embodiment of the present invention.

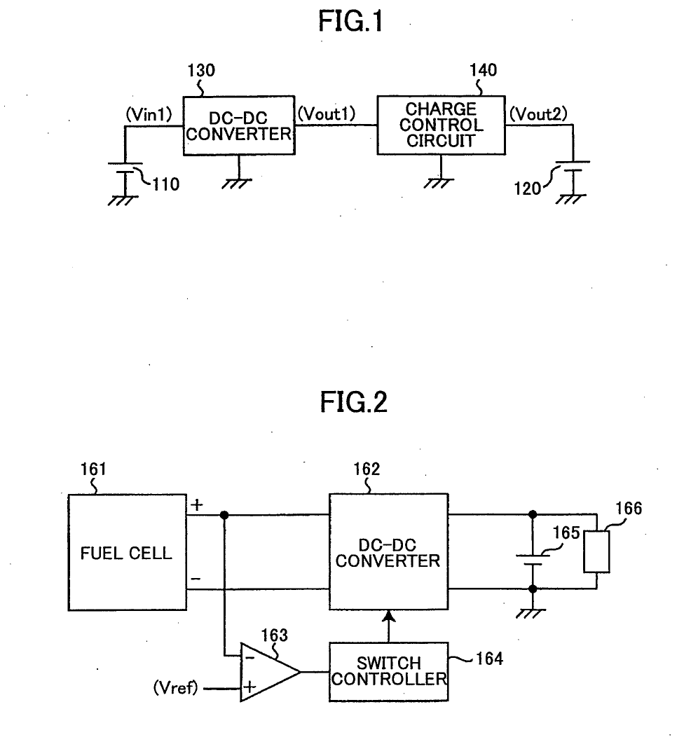

### BEST MODE FOR CARRYING OUT THE INVENTION

A description is given below, with reference to the accompanying drawings, of embodiments of the present invention.

### First Embodiment

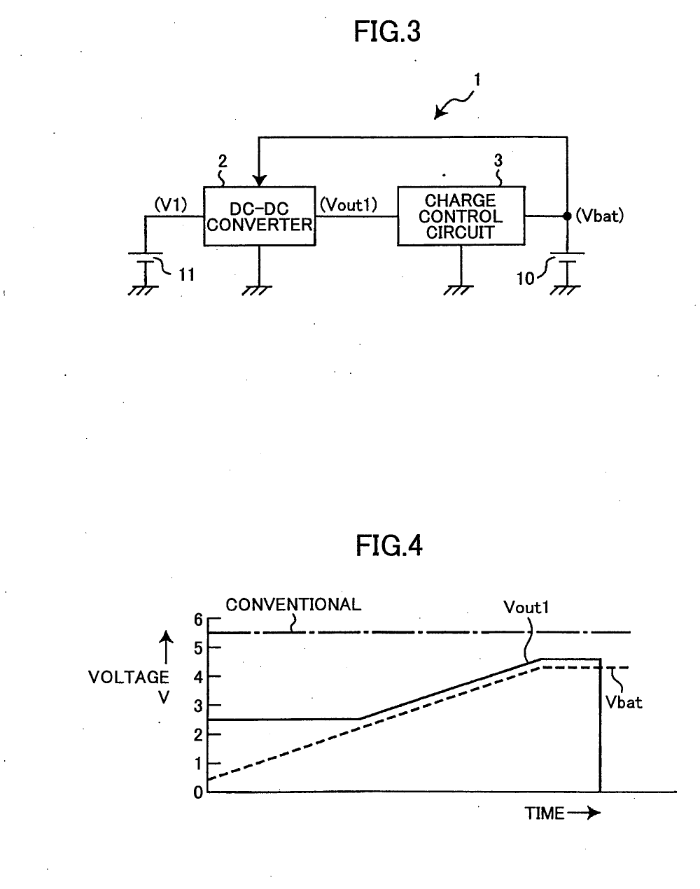

FIG. 3 is a schematic block diagram showing a charging unit 1 according to a first embodiment of the present invention.

Referring to FIG. 3, the charging unit 1, which charges a secondary battery 10 such as a lithium-ion battery, includes a DC-DC converter 2 such as a step-up switching regulator, a charge control circuit 3 that performs predetermined constant-current, constant-voltage charging on the secondary battery 10 using an output voltage Vout 1 output from the DC-DC converter 2, and a first direct-current (DC) power supply 11 formed of a battery such as a fuel cell or a solar battery. Hereinafter, the term “fuel cell” may also refer to a stack of fuel cells.

A first voltage V1 is input to the DC-DC converter 2 from the first DC power supply 11. The DC-DC converter 2 increases the first voltage V1 so that the first voltage V1 is proportional to a battery voltage Vbat, for example, greater than the battery voltage Vbat by a predetermined value, and outputs the increased first voltage V1 to the charge control circuit 3 as the output voltage Vout 1. The battery voltage Vbat is the voltage across the secondary battery 10. The DC-DC converter 2 and the first DC power supply 11 may form a power supply circuit.

FIG. 4 is a graph showing changes in the output voltage Vout1 of the DC-DC converter 2 and the battery voltage Vbat of the secondary battery 10 at the time of charging. In FIG. 4, the horizontal axis represents time.

Referring to FIG. 4, the solid line indicates the output voltage Vout1 of the DC-DC converter 2, the broken, line indicates the battery voltage Vbat of the secondary battery 10, and the one-dot chain line indicates the output voltage of the conventional DC-DC converter.

The output voltage of the conventional DC-DC converter is fixed at approximately 5.4 V, while the output voltage Vout1 of the DC-DC converter 2 is approximately 0.2 V greater than the battery voltage Vbat of the secondary battery 10. The 0.2 V difference, which is the difference between the output voltage Vout1 of the DC-DC converter 2 and the battery voltage Vbat of the secondary battery 10, is a voltage difference necessary for the operation of the charge control circuit 3, and is determined by the elements forming the charge control circuit 3 and the value of a charging current to the secondary battery 10. Thus, the DC-DC converter 2 changes the output voltage Vout 1 in accordance with the battery voltage Vbat of the secondary battery 10.

Further, there is a limit to the lower limit value of the output voltage Vout1 of the DC-DC converter 2. The DC-DC converter 2 controls the output voltage Vout1 so that the output voltage Vout1 is prevented from being less than or equal to, for example, 2.5 V if the battery voltage Vbat of the secondary battery 10 is less than or equal to a predetermined voltage. This is because the charge control circuit 3 cannot start to charge the secondary battery 10 if the output voltage Vout1 of the DC-DC converter 2 is lower than the minimum operating voltage of the charge control circuit 3. Therefore, the DC-DC converter 2 restricts the lower limit of the output voltage Vout1 to a value above and around or equal to the minimum operating voltage of the charge control circuit 3.

The voltage per cell of the fuel cell or solar battery used as the DC power supply 11 is as low as 1 V or less, and multiple cells are connected in series to output a voltage of approximately 2 V. For example, if the first voltage V1 supplied from the first DC power supply 11 is 2 V, a step-up switching regulator is used as the DC-DC converter 2 as described above. It is known that the efficiency of the switching regulator is better as the ratio of the output voltage to the input voltage is smaller. Therefore, if the DC-DC converter 2 outputs a voltage approximate to the battery voltage Vbat with a low first voltage V1 from the first DC power supply 11, the efficiency of the DC-DC converter 2 itself is better than in the conventional case of constantly outputting 5.4 V, so that it is possible to perform charging with higher efficiency.

For example, it is assumed that the first voltage V1 is 2 V, the average voltage of the secondary battery 10 during charging is 3 V, the charging current is 500 mA, the self-consumption current of the charge control circuit 3 is 3 mA, and the output voltage Vout1 of the DC-DC converter 2 is the secondary battery voltage Vbat plus 0.2 V. Further, it is assumed that the efficiency of the DC-DC converter 2 is 81.8% if the input voltage Vin is 2 V and the output voltage Vout1 is 5.4 V and is 93.6% if the input voltage Vin is 2 V and the output voltage Vout1 is 3.2 V. In this case, the charging efficiency by the conventional method is 0.818×(3.0×0.5)/(5.4×(0.5+0.003))×100≈45.2%, while the charging efficiency by the present invention is 0.936×(3.0×0.5)/(3.2×(0.5+0.003))×100≈87.2%. Thus, the efficiency can be nearly twice as much as conventionally.

Thus, according to the charging unit 1 of the first embodiment, the DC-DC converter 2 increases the first voltage V1 so that the first voltage V1 is proportional to the battery voltage Vbat of the secondary battery 10, for example, greater than the battery voltage Vbat by a predetermined value, and outputs the increased first voltage V1 to the charge control circuit 3 as the output voltage Vout 1; and the charge control circuit 3 performs predetermined constant-current, constant-voltage charging on the secondary battery 10 using the output voltage Vout1 as power supply. This makes it possible to perform common constant-current, constant-voltage charging on a secondary battery. Accordingly, it is possible to charge the lithium-ion battery, whose charging conditions are strict, with high accuracy, so that it is possible to supply the charge control circuit 3 with a voltage that is the battery voltage Vbat of the secondary battery 10 plus a required minimum voltage at the time of charging the secondary battery 10 using a fuel cell or a solar battery. As a result, the power loss in the charge control circuit 3 is significantly reduced, so that it is possible to improve charging efficiency. Further, since the voltage increase rate of the DC-DC converter 2 may be low, the DC-DC converter 2 can operate with high efficiency, so that it is possible to further increase charging efficiency.

### Second Embodiment

In the first embodiment, power is supplied to the DC-DC converter 2 only from the first DC power supply 11. Alternatively, according to a second embodiment of the present invention, power may be supplied from two DC current sources, that is, a first DC current source and a second DC current source, to the DC-DC converter, and the supply voltage from the first DC power supply may be increased and supplied to a charge control circuit when the supply voltage from the second DC power supply becomes lower than a predetermined value.

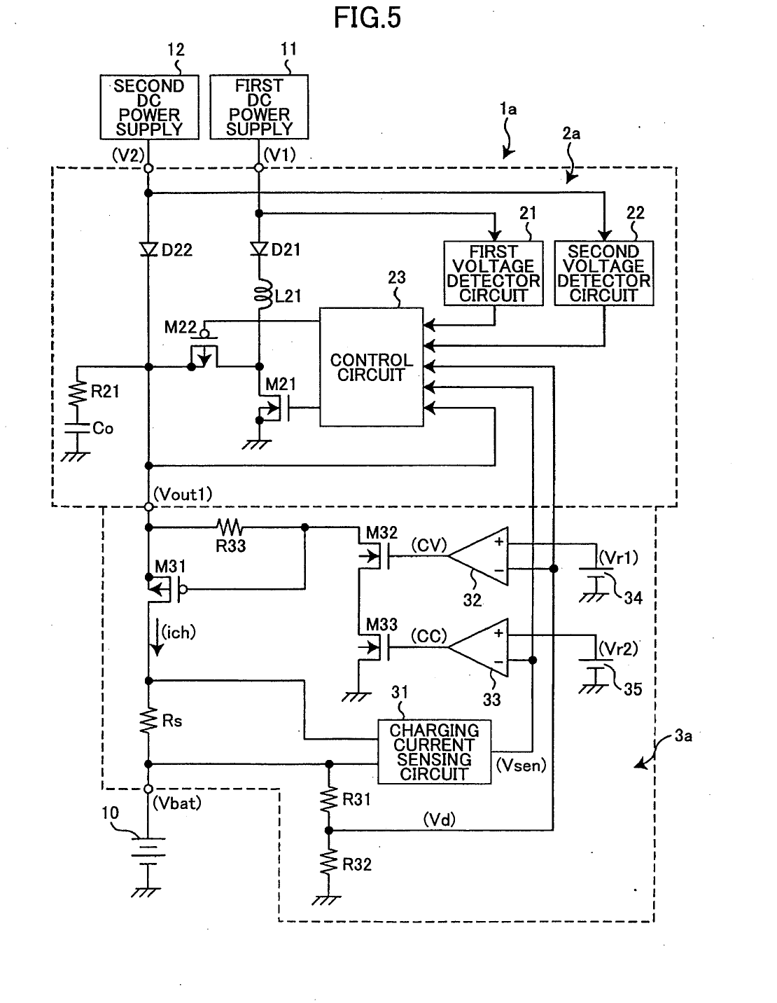

FIG. 5 is a circuit diagram showing a charging unit 1a according to the second embodiment of the present invention. In FIG. 5, the same elements as those of FIG. 3 are referred to by the same reference numerals.

Referring to FIG. 5, the charging unit 1a, which charges the secondary battery 10 such as a lithium-ion battery, includes a DC-DC converter 2a forming a step-up switching regulator, a charge control circuit 3a that performs predetermined constant-current, constant-voltage charging on the secondary battery 10 using an output voltage Vout 1 output from the DC-DC converter 2a, the first DC power supply 11 formed of a battery such as a fuel cell or a solar battery, and a second DC power supply 12 that generates and outputs a predetermined voltage based on externally supplied power, such as an AC adapter. The DC-DC converter 2a, the first DC power supply 11, and the second DC power supply 12 may form a power supply circuit. The first voltage V1 is input to the DC-DC converter 2a from the first DC power supply 11, and a predetermined second voltage V2 is input to the DC-DC converter 2a from the second DC power supply 12.

The graph showing changes in the output voltage Vout1 of the DC-DC converter 2a and the battery voltage Vbat of the secondary battery 10 at the time of charging in the case where the second DC power supply 12 is not connected to the DC-DC converter 2a is the same as that of FIG. 4, and accordingly is omitted.

The DC-DC converter 2a detects the first voltage V1 and the second voltage V2, and if the second voltage V2 is less than a second predetermined value (which also includes the case where the second voltage V2 is not input), the DC-DC converter 2a increases the first voltage V1 as shown in FIG. 4 and outputs the increased first voltage V1 to the charge control circuit 3a as the output voltage Vout1. Further, if the second voltage V2 is greater than or equal to the second predetermined voltage, the DC-DC converter 2a stops increasing the first voltage V1, thereby outputting the second voltage V2 to the charge control circuit 3a as the output voltage Vout1. The charge control circuit 3a operates using the voltage Vout1 input from the DC-DC converter 2a as power supply so as to perform the predetermined constant-current, constant-voltage charging on the secondary battery 10.

The DC-DC converter 2a includes a switching transistor M21 formed of an NMOS transistor, a transistor for synchronous rectification (synchronous rectification transistor) M22 formed of a PMOS transistor, diodes D21 and D22 for reverse current prevention, an inductor L21, a resistor 21 and an output capacitor Co for smoothing, a first voltage detector circuit 21 that detects the first voltage V1, a second voltage detector circuit 22 that detects the second voltage V2, and a control circuit 23 that controls the operations of the switching transistor M21 and the synchronous rectification transistor M22.

Further, the charge control circuit 3a includes a transistor for charging (charging transistor) M31 formed of a PMOS transistor, which supplies the secondary battery 10 with a current according to a signal input to its gate; resistors R31 and R32 that divide the battery voltage Vbat of the secondary battery 10 and output a divided voltage Vd; a resistor R33 forming a pull-up resistor; a resistor Rs for charging current detection; a charging current sensing circuit 31 that detects a charging current ich to the secondary battery 10 from the voltage across the resistor Rs; operational amplifier circuits 32 and 33; a first reference voltage generator circuit 34 that generates and outputs a predetermined first reference voltage Vr1; a second reference voltage generator circuit 35 that generates and outputs a predetermined second reference voltage Vr2; and NMOS transistors M32 and M33.

In the DC-DC converter 2a, the first voltage V1 is input to the anode of the diode D21, and the inductor L21 and the switching transistor M21 are connected in series between the cathode of the diode D21 and ground. The second voltage V2 is input to the anode of the diode D22, and the cathode of the diode D22 is connected to the source of the charging transistor M31. The synchronous rectification transistor M22 is connected between the connection of the diode D22 and the charging transistor M31 and the connection of the inductor L21 and the switching transistor M21.

The connection of the diode D22 and the synchronous rectification transistor M22 forms the output of the DC-DC converter 2a, and the output voltage Vout1 of the DC-DC converter 2a, which is the voltage at the output of the DC-DC converter 2a, is input to the control circuit 23. The resistor R21 and the output capacitor Co are connected in series between the output of the DC-DC converter 2a and ground. Further, the first voltage V1 and the second voltage V2 are input to the first voltage detector circuit 21 and the second voltage detector circuit 22, respectively, and the detection result of each of the first voltage detector circuit 21 and the second voltage detector circuit 22 is output to the control circuit 23.

In the charge control circuit 3a, the resistor R33 is connected between the output of the DC-DC converter 2a and the gate of the charging transistor M31, and the output voltage Vout1 of the DC-DC converter 2a is input to the source of the charging transistor M31. The resistor Rs is connected between the drain of the charging transistor M31 and the positive electrode of the secondary battery 10, and the negative electrode of the secondary battery 10 is grounded. The resistor R31 and the resistor R32 are connected in series between the connection of the resistor Rs and the secondary battery 10 and ground, and the divided voltage Vd obtained by dividing the battery voltage Vbat is output from the connection of the resistor R31 and the resistor R32 to the control circuit 23 and to the inverting input of the operational amplifier circuit 32.

The voltage across the resistor Rs is input to the charging current sensing circuit 31, and the charging current sensing circuit 31 outputs a signal Vsen indicating the current value of the detected charging current ich to the control circuit 23 and to the inverting input of the operational amplifier circuit 33. The NMOS transistors M32 and M33 are connected in series between the gate of the charging transistor M31 and ground. The first reference voltage Vr1 is input to the non-inverting input of the operational amplifier circuit 32, and the output of the operational amplifier circuit 32 is connected to the gate of the NMOS transistor M32. Further, the second reference voltage Vr2 is input to the non-inverting input of the operational amplifier circuit 33, and the output of the operational amplifier circuit 33 is connected to the gate of the NMOS transistor M33.

The first voltage detector circuit 21 and the control circuit 23 operate using the first voltage V1 as power supply, the second voltage detector circuit 22 operates using the second voltage V2 as power supply, and the charge control circuit 3a operates using the output voltage Vout1 of the DC-DC converter 2a as power supply.

According to this configuration, the first voltage detector circuit 21 outputs a signal indicating whether the first voltage V1 from the first DC power supply 11 is greater than or equal to a first predetermined value to the control circuit 23. Likewise, the second voltage detector circuit 22 outputs a signal indicating whether the second voltage V2 from the second DC power supply 12 is greater than or equal to the second predetermined value to the control circuit 23. If the second voltage detector circuit 22 detects the second voltage V2 from the second DC power supply 12 being greater than or equal to the second predetermined value, the control circuit 23 stops increasing voltage by turning OFF both the switching transistor M21 and the synchronous rectification transistor M22 so that they are in a non-conducting state. In this state, the second voltage V2 from the second DC power supply 12 is input to the charge control circuit 3a via the diode D22, so that the charge control circuit 3a charges the secondary battery 10 using the second voltage V2 as power supply. In this situation, even if the first voltage detector circuit 21 detects the first voltage V1 from the first DC power supply 11 being greater than or equal to the first predetermined value, the control circuit 23 ignores the detection result input thereto from the first voltage detector circuit 21.

If the second voltage detector circuit 22 detects the second voltage V2 being less than the second predetermined value and the first voltage detector circuit 21 detects the first voltage V1 being greater than or equal to the first predetermined value, the control circuit 23 increases the first voltage V1 by complementarily performing ON-OFF control on the switching transistor M21 and the synchronous rectification transistor M22 by, for example, performing PWM control so that a voltage Vfb proportional to the output voltage Vout1 is equal to a set reference voltage Vref. The increased voltage is output to the charge control circuit 3a as the output voltage Vout1. As a result, the secondary battery 10 is charged using the first DC power supply 11 as power supply.

Here, the divided voltage Vd obtained by dividing the battery voltage Vbat is input to the control circuit 23. The control circuit 23 changes the value of the reference voltage Vref in accordance with the divided voltage Vd so that the output voltage Vout1 of the DC-DC converter 2a is, for example, 0.2 V greater than the battery voltage Vbat of the secondary battery 10. How much the output voltage Vout1 is greater than the battery voltage Vbat of the secondary battery 10 varies depending on the resistor Rs and the characteristics of the charging transistor M31 of the charge control circuit 3a. Further, as described above with reference to FIG. 4, if the battery voltage Vbat of the secondary battery 10 is less than or equal to a predetermined voltage, the control circuit 23 determines the reference voltage Vref so that the output voltage Vout 1 is prevented from becoming, for example, 2.5 V or less.

Further, if the first voltage detector circuit 21 detects the first voltage V1 being less than the first predetermined value and the second voltage detector circuit 22 detects the second voltage V2 being less than the second predetermined value, the control circuit 23 stops increasing voltage by turning OFF both the switching transistor M21 and the synchronous rectification transistor M22 so that they are in a non-conducting state. In this state, the second voltage V2 from the second DC power supply 12 is input to the charge control circuit 3a via the diode D22. However, the charge control circuit 3a cannot secure enough power supply to charge the secondary battery 10 so as to substantially stop charging the secondary battery 10.

Next, a description is given of an operation of the charge control circuit 3a.

If the battery voltage Vbat of the secondary battery 10 is low so that the divided voltage Vd is less than the first reference voltage Vr1, the output signal CV of the operational amplifier circuit 32 becomes HIGH (high-level signal), so that the NMOS transistor M32 turns ON. The operational amplifier circuit 33 controls the charging current ich that is the drain current of the charging transistor M31 by controlling the operation of the NMOS transistor M33 so that the output signal Vsen of the charge current sensing circuit 31 is equalized with the second reference voltage Vr2. That is, constant-current charging with the drain current of the charging transistor M31 is performed on the secondary battery 10.

If the divided voltage Vd is greater than or equal to the first reference voltage Vr1, the voltage of the output signal CV of the operational amplifier circuit 32 decreases, so that the operational amplifier circuit 32 controls the charging transistor M31 via the NMOS transistor M32 so as to equalize the divided voltage Vd with the first reference voltage Vr1. As a result, constant-voltage charging is performed. In the state of constant-voltage charging, the drain current of the charging transistor M31 is reduced compared with at the time of constant-current charging. Therefore, the signal Vsen from the charging current sensing circuit 31 is less than the second reference voltage Vr2. As a result, the output signal CC of the operational amplifier circuit 33 becomes HIGH (high-level signal), so that the NMOS transistor M33 turns ON to be in a conducting state. As a result, the constant-current charging is terminated, and constant-voltage charging with the drain current of the charging transistor M31 is performed.

If the control circuit 23 detects the charging current ich being less than or equal to a predetermined value from the output signal Vsen of the charging current sensing circuit 31 during the constant-voltage charging, the control circuit 23 stops increasing voltage by turning OFF both the switching transistor M21 and the synchronous rectification transistor M22. Therefore, as shown in FIG. 4, if the second DC power supply 12 is not connected, the output voltage Vout1 of the DC-DC converter 2a becomes 0 V, so that the charging of the secondary battery 10 by the charge control circuit 3a is stopped. Referring to FIG. 4, at the time of constant-voltage charging, the charging current ich becomes less than or equal to a predetermined value so that the NMOS transistor M33 turns OFF to be non-conducting and the charging transistor M31 turns OFF to be non-conducting before the output voltage Vout1 becomes 0 V. Further, the charging of the secondary battery 10 is also stopped irrespective of the value of the first voltage V1 in the case where the second DC power supply 12 is connected and the second voltage V2 is less than the second predetermined value.

Thus, according to the charging unit 1a of the second embodiment, in the case of using the first DC power supply 11 and the second DC power supply 12 formed of an AC adapter or the like in parallel, preferential use is made of the second voltage V2 from the second DC power supply 12 to charge the secondary battery 10. As a result, it is possible to produce the same effects as in the above-described first embodiment and to reduce fuel consumption in the case of using a fuel cell for the first DC power supply 11.

### Third Embodiment

In the above-described second embodiment, the DC-DC converter 2a does not perform output control of the second voltage V2 and only controls the operation of increasing the first voltage V1. Alternatively, according to a third embodiment of the present invention, the DC-DC converter may control output of the second voltage V2 to the charge control circuit 3a in accordance with the value of the second voltage V2.

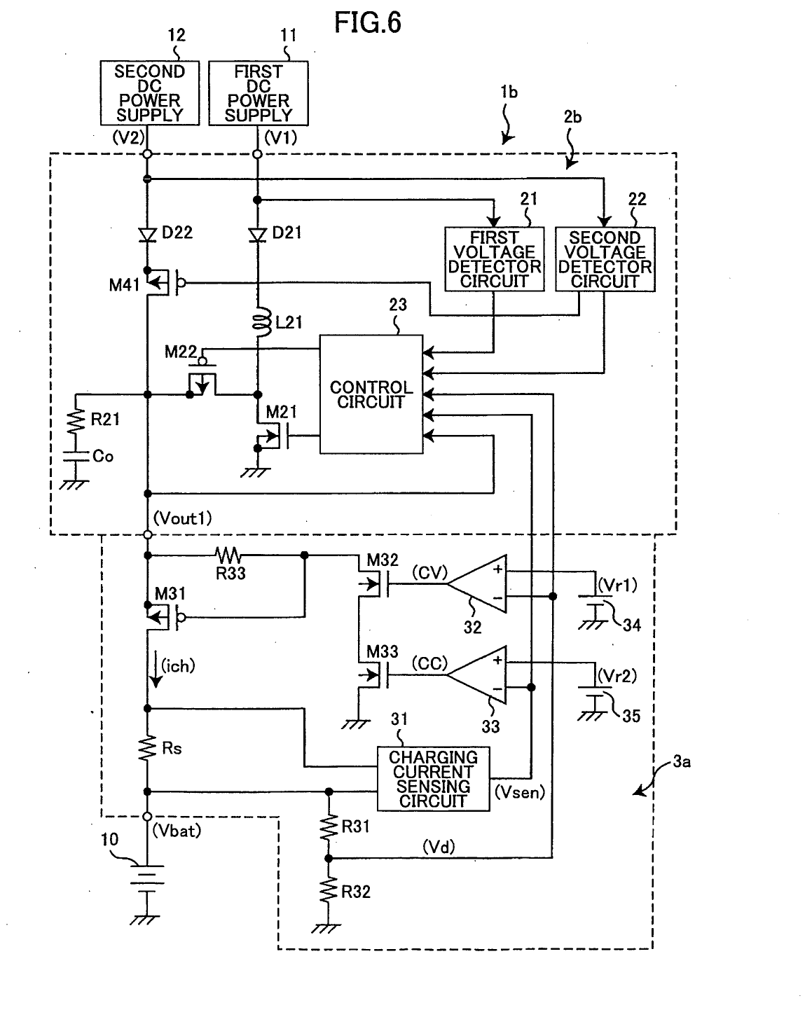

FIG. 6 is a circuit diagram showing a charging unit 1b according to the third embodiment of the present invention. In FIG. 6, the same elements as those of FIG. 5 are referred to by the same reference numerals, and a description thereof is omitted.

There is a difference between FIGS. 5 and 6 in that a PMOS transistor M41 that controls output of the second voltage V2 to the charge control circuit 3a in accordance with the detection result of the second voltage V2 by the second voltage detector circuit 22 is added in FIG. 6.

Referring to FIG. 6, the charging unit 1b, which charges the secondary battery 10, includes a DC-DC converter 2b forming a step-up switching regulator, the charge control circuit 3a that performs predetermined constant-current, constant-voltage charging on the secondary battery 10 using an output voltage Vout 1 output from the DC-DC converter 2b, the first DC power supply 11, and the second DC power supply 12. The DC-DC converter 2b, the first DC power supply 11, and the second DC power supply 12 may form a power supply circuit.

The first voltage V1 is input to the DC-DC converter 2b from the first DC power supply 11, and the second voltage V2 is input to the DC-DC converter 2b from the second DC power supply 12.

The graph showing changes in the output voltage Vout1 of the DC-DC converter 2b and the battery voltage Vbat of the secondary battery 10 at the time of charging in the case where the second DC power supply 12 is not connected to the DC-DC converter 2b is the same as that of FIG. 4, and accordingly is omitted.

The DC-DC converter 2b detects the first voltage V1 and the second voltage V2, and if the second voltage V2 is less than a second predetermined value (which also includes the case where the second voltage V2 is not input), the DC-DC converter 2b interrupts output of the second voltage V2 to the charge control circuit 3a, and increases the first voltage V1 as shown in FIG. 4 and outputs the increased first voltage V1 to the charge control circuit 3a as the output voltage Vout1. Further, if the second voltage V2 is greater than or equal to the second predetermined voltage, the DC-DC converter 2b stops increasing the first voltage V1, and outputs the second voltage V2 to the charge control circuit 3a as the output voltage Vout1. The charge control circuit 3a operates using the voltage Vout1 input from the DC-DC converter 2b as power supply so as to perform the predetermined constant-current, constant-voltage charging on the secondary battery 10.

The DC-DC converter 2b includes the switching transistor M21, the synchronous rectification transistor M22, the diodes D21 and D22 for reverse current protection, the inductor L21, the resistor R21 and the output capacitor Co for smoothing, the first voltage detector circuit 21, the second voltage detector circuit 22, the control circuit 23, and the PMOS transistor M41. The first voltage detector circuit 21 and the control circuit 23 operate using the first voltage V1 as power supply, the second voltage detector circuit 22 operates using the second voltage V2 as power supply, and the charge control circuit 3a operates using the output voltage Vout1 of the DC-DC converter 2b as power supply.

The second voltage detector circuit 22 turns OFF the PMOS transistor M41 so that the PMOS transistor M41 is non-conducting only if the second voltage V2 is less than the second predetermined value, and turns ON the PMOS transistor M41 so that the PMOS transistor M41 is conducting if the second voltage V2 is greater than or equal to the second predetermined value. The other operations are the same as in the case of FIG. 5, and accordingly, a description thereof is omitted.

Thus, according to the charging unit 1b of the third embodiment, in the case of using the first DC power supply 11 and the second DC power supply 12 formed of an AC adapter or the like in parallel, preferential use is made of the second voltage V2 from the second DC power supply 12 to charge the secondary battery 10, and if the second voltage V2 is less than the second predetermined value (which also includes the case where the second voltage V2 is not input), the output of the second voltage V2 to the charge control circuit 3a is interrupted. As a result, it is possible to produce the same effects, as in the above-described second embodiment.

The second predetermined value in the above-described second and third embodiments may be determined so as to be the sum of the ON-time voltage drop of the charging transistor M31, the voltage drop of the resistor Rs, and the battery voltage Vbat of the fully charged secondary battery 10.

According to one embodiment of the present invention, there is provided a power supply circuit supplying power to a charge control circuit charging a secondary battery, the power supply circuit including a first direct-current power supply configured to generate and output a predetermined first voltage; and a DC-DC converter configured to detect the voltage of the secondary battery, convert the first voltage input from the first direct-current power supply into a voltage according to the detected voltage of the secondary battery, and output the converted first voltage to the charge control circuit. Additionally, in the power supply circuit, the DC-DC converter may be a step-up switching regulator.

Additionally, the power supply circuit may further include a second direct-current power supply configured to generate a predetermined second voltage, wherein the DC-DC converter may be configured to output only the second voltage to the charge control circuit as the power if the second voltage is greater than or equal to a predetermined value, and to convert the first voltage from the first direct-current power supply into the voltage according to the detected voltage of the secondary battery, and output the converted first voltage and the second voltage to the charge control circuit as the power if the second voltage is less than the second predetermined value.

Additionally, the power supply circuit may further include a second direct-current power supply configured to generate a predetermined second voltage, wherein the DC-DC converter may be configured to output the second voltage to the charge control circuit as the power if the second voltage is greater than or equal to a predetermined value, and to convert the first voltage from the first direct-current power supply into the voltage according to the detected voltage of the secondary battery, and output the converted first voltage to the charge control circuit as the power if the second voltage is less than the second predetermined value.

According to one embodiment of the present invention, there is provided a charging unit charging a secondary battery, the charging unit including a charge control circuit configured to charge the secondary battery; and a power supply circuit configured to supply power to the charge control circuit, wherein the power supply circuit includes a first direct-current power supply configured to generate and output a first predetermined voltage; and a DC-DC converter configured to detect the voltage of the secondary battery, convert the first voltage input from the first direct-current power supply into a voltage according to the detected voltage of the secondary battery, and output the converted first voltage to the charge control circuit. Additionally, in the charging unit, the DC-DC converter may be a step-up switching regulator.

Additionally, in the charging unit, the power supply circuit may further include a second direct-current power supply configured to generate a predetermined second voltage, wherein the DC-DC converter may be configured to output only the second voltage to the charge control circuit as the power if the second voltage is greater than or equal to a predetermined value, and to convert the first voltage from the first direct-current power supply into the voltage according to the detected voltage of the secondary battery, and output the converted first voltage and the second voltage to the charge control circuit as the power if the second voltage is less than the second predetermined value.

Additionally, in the charging unit, the power supply circuit may further include a second direct-current power supply configured to generate a predetermined second voltage, wherein the DC-DC converter may be configured to output the second voltage to the charge control circuit as the power if the second voltage is greater than or equal to a predetermined value, and to convert the first voltage from the first direct-current power supply into the voltage according to the detected voltage of the secondary battery, and output the converted first voltage to the charge control circuit as the power if the second voltage is less than the second predetermined value.

According to one embodiment of the present invention, there is provided a method of supplying power to a charge control circuit charging a secondary battery, the method including detecting the voltage of the secondary battery; and converting a predetermined first voltage input from a first direct-current power supply into a voltage according to the detected voltage of the secondary battery, and outputting the converted first voltage to the charge control circuit.

Additionally, in the method, only a predetermined second voltage input from a second direct-current power supply generating and outputting the second voltage may be output to the charge control circuit as the power if the second voltage is greater than or equal to a second predetermined value, and the first voltage from the first direct-current power supply may be converted into the voltage according to the detected voltage of the secondary battery, and may be output together with the second voltage to the charge control circuit as the power if the second voltage is less than the second predetermined value.

Additionally, in the method, a predetermined second voltage input from a second direct-current power supply generating and outputting the second voltage may be output to the charge control circuit as the power if the second voltage is greater than or equal to a predetermined value, and the first voltage from the first direct-current power supply may be converted into the voltage according to the detected voltage of the secondary battery, and may be output to the charge control circuit as the power if the second voltage is less than the second predetermined value.

Thus, according to a power supply circuit supplying power to a charge control circuit, a charging unit having the power supply circuit, and a method of supplying power to the charge control circuit according to one or more embodiments of the present invention, the voltage of a secondary battery is detected, and a predetermined first voltage input from a first direct-current power supply is converted into a voltage according to the detected voltage of the secondary battery and output to the charge control circuit. This makes it possible to perform common constant-current, constant-voltage charging on the secondary battery. Accordingly, it is possible to charge the lithium-ion battery, whose charging conditions are strict, with high accuracy, so that it is possible to supply the charge control circuit with a voltage that is the battery voltage of the secondary battery plus a required minimum voltage at the time of charging the secondary battery using a fuel cell or a solar battery. As a result, the power loss in the charge control circuit is significantly reduced, so that it is possible to improve charging efficiency.

Further, in the case of using an AC adapter or the like for a second direct-current power supply, the AC adapter is given preference in charging. Accordingly, it is possible to reduce fuel consumption of a fuel cell in the case of using the fuel cell for the first direct-current power supply.

Further, according to the power supply circuit supplying power to the charge control circuit and the charging unit having the power supply circuit, in the case of using a step-up switching regulator for a DC-DC converter, it is possible to reduce the voltage increase rate of the DC-DC converter, so that it is possible to cause the DC-DC converter to operate with high efficiency. Accordingly, it is possible to further increase charging efficiency.

The present invention is not limited to the specifically disclosed embodiments, and variations and modifications may be made without departing from the scope of the present invention.

The present application is based on Japanese Priority Patent Application No. 2007-033061, filed on Feb. 14, 2007, the entire contents of which are hereby incorporated by reference.

1. A power supply circuit supplying power to a charge control circuit charging a secondary battery, the power supply circuit comprising:
a direct-current power supply configured to generate and output a predetermined voltage; and
a DC-DC converter configured to detect a voltage of the secondary battery, convert the predetermined voltage input from the direct-current power supply into a voltage according to the detected voltage of the secondary battery, and output the converted voltage to the charge control circuit.

2. The power supply circuit as claimed in claim 1, wherein the DC-DC converter is configured to convert and output the predetermined voltage input from the direct-current power supply so that a difference between the converted voltage and the detected voltage of the secondary battery is a predetermined value.

3. The power supply circuit as claimed in claim 1, wherein the DC-DC converter is configured to generate a predetermined minimum voltage required for the charge control circuit to operate irrespective of the voltage of the secondary battery and output the generated predetermined minimum voltage to the charge control circuit in response to the voltage of the secondary battery being less than or equal to a predetermined value.

4. The power supply circuit as claimed in claim 1, wherein the direct-current power supply is a fuel cell generating and outputting the predetermined voltage.

5. The power supply circuit as claimed in claim 1, wherein the direct-current power supply is a solar battery generating and outputting the predetermined voltage.

6. The power supply circuit as claimed in claim 1, wherein the DC-DC converter is a step-up switching regulator.

7. The power supply circuit as claimed in claim 1, further comprising:
an additional direct-current power supply configured to generate a predetermined additional voltage,
wherein the DC-DC converter is configured to output only the additional voltage to the charge control circuit as the power in response to the additional voltage being greater than or equal to a predetermined value, and to convert the predetermined voltage from the direct-current power supply into the voltage according to the detected voltage of the secondary battery, and output the converted voltage and the additional voltage to the charge control circuit as the power in response to the additional voltage being less than the corresponding predetermined value.

8. The power supply circuit as claimed in claim 1, further comprising:
an additional direct-current power supply configured to generate a predetermined additional voltage,
wherein the DC-DC converter is configured to output the additional voltage to the charge control circuit as the power in response to the additional voltage being greater than or equal to a predetermined value, and to convert the predetermined voltage from the direct-current power supply into the voltage according to the detected voltage of the secondary battery, and output the converted voltage to the charge control circuit as the power in response to the additional voltage being less than the corresponding predetermined value.

9. The power supply circuit as claimed in claim 1, wherein the DC-DC converter is configured to stop converting and outputting the predetermined voltage in response to detecting, from the voltage of the secondary battery, the secondary battery being fully charged.

10. A charging unit charging a secondary battery, the charging unit comprising:
a charge control circuit configured to charge the secondary battery; and
a power supply circuit configured to supply power to the charge control circuit,
wherein the power supply circuit includes
a direct-current power supply configured to generate and output a predetermined voltage; and
a DC-DC converter configured to detect a voltage of the secondary battery, convert the predetermined voltage input from the direct-current power supply into a voltage according to the detected voltage of the secondary battery, and output the converted voltage to the charge control circuit.

11. The charging unit as claimed in claim 10, wherein the DC-DC converter is configured to convert and output the predetermined voltage input from the direct-current power supply so that a difference between the converted voltage and the detected voltage of the secondary battery is a predetermined value.

12. The charging unit as claimed in claim 10, wherein the DC-DC converter is configured to generate a predetermined minimum voltage required for the charge control circuit to operate irrespective of the voltage of the secondary battery and output the generated predetermined minimum voltage to the charge control circuit in response to the voltage of the secondary battery being less than or equal to a predetermined value.

13. The charging unit as claimed in claim 10, wherein the direct-current power supply is a fuel cell generating and outputting the predetermined voltage.

14. The charging unit as claimed in claim 10, wherein the direct-current power supply is a solar battery generating and outputting the predetermined voltage.

15. The charging unit as claimed in claim 10, wherein the DC-DC converter is a step-up switching regulator.

16. The charging unit as claimed in claim 10, wherein:
the power supply circuit further comprises an additional direct-current power supply configured to generate a predetermined additional voltage; and
the DC-DC converter is configured to output only the additional voltage to the charge control circuit as the power in response to the additional voltage being greater than or equal to a predetermined value, and to convert the predetermined voltage from the direct-current power supply into the voltage according to the detected voltage of the secondary battery, and output the converted voltage and the additional voltage to the charge control circuit as the power in response to the additional voltage being less than the corresponding predetermined value.

17. The charging unit as claimed in claim 10, wherein:
the power supply circuit further comprises an additional direct-current power supply configured to generate a predetermined additional voltage; and
the DC-DC converter is configured to output the additional voltage to the charge control circuit as the power in response to the additional voltage being greater than or equal to a predetermined value, and to convert the predetermined voltage from the direct-current power supply into the voltage according to the detected voltage of the secondary battery, and output the converted voltage to the charge control circuit as the power in response to the additional voltage being less than the corresponding predetermined value.

18. The charging unit as claimed in claim 10, wherein the DC-DC converter is configured to stop converting and outputting the predetermined voltage in response to detecting, from the voltage of the secondary battery, the secondary battery being fully charged.

19. The charging unit as claimed in claim 10, wherein the DC-DC converter and the charge control circuit are integrated into a single IC.

20. A method of supplying power to a charge control circuit charging a secondary battery, the method comprising:
detecting a voltage of the secondary battery; and
converting a predetermined voltage input from a direct-current power supply into a voltage according to the detected voltage of the secondary battery, and outputting the converted voltage to the charge control circuit.

21-25. (canceled)
